(19) United States
(12) Patent Application Publication
(10) Pub. No.: US 2024/0343582 A1
(43) Pub. Date: Oct. 17, 2024

(54) METHOD FOR PREPARING POROUS MICROSPHERE CARBON ANODE MATERIAL AND APPLICATION THEREOF

(71) Applicants: GUANGDONG BRUNP RECYCLING TECHNOLOGY CO., LTD., Foshan, Guangdong (CN); HUNAN BRUNP RECYCLING TECHNOLOGY CO., LTD., Changsha, Hunan (CN); HUNAN BRUNP EV RECYCLING CO., LTD., Changsha, Hunan (CN)

(72) Inventors: Maohua Feng, Foshan, Guangdong (CN); Changdong Li, Foshan, Guangdong (CN); Xingyu Wu, Foshan, Guangdong (CN); Dingshan Ruan, Foshan, Guangdong (CN); Baoye Liu, Foshan, Guangdong (CN)

(21) Appl. No.: 18/684,834

(22) PCT Filed: Nov. 15, 2022
(86) PCT No.: PCT/CN2022/131913

§ 371 Date: Feb. 19, 2024

(30) Foreign Application Priority Data
Mar. 30, 2022 (CN) 202210326495.1

(51) Int. Cl. C01B 32/05; H01M 4/02; H01M 4/587

(52) U.S. Cl. CPC C01B 32/05; H01M 4/587; C01P 2004/03; C01P 2004/32; C01P 2004/62; C01P 2006/12; C01P 2006/40; H01M 2004/027

(57) ABSTRACT

The present disclosure discloses a method for preparing a porous microsphere carbon negative electrode material and an application thereof, the method comprising steps of: mixing plant fiber with a halogenated lithium salt to obtain a mixed solid, heating the mixed solid and introducing an oxidizing gas to obtain a pre-dissociated product; mixing the pre-dissociated product with a dissociation solution and heating for reaction to obtain a dissociated cellulose solution; and adding a hybrid to the dissociated cellulose solution to obtain a hybrid solution, spray-drying the hybrid solution to obtain a microsphere precursor, and heating the microsphere precursor in an inert atmosphere to obtain the porous microsphere carbon negative electrode material.

### FIELD

The present disclosure belongs to the technical field of secondary batteries, and specifically relates to a method for preparing a porous microsphere carbon anode material and an application thereof.

### BACKGROUND

With the gradual depletion of fossil fuels, energy storage has become one of the most important research areas in the 21st century. For this reason, lithium-ion batteries (LIBs) have attracted extensive attention due to their advantages of high energy density, long service life and good environmental compatibility. However, a variety of emerging battery applications, for example, in portable electronics, electric vehicles and renewable power station, require higher voltage, higher energy density and superior rate performance while increasing costs, cycle life and safety. In order to relieve the pressure of mineral resources exploration, carbon electrode materials that can store lithium like graphite have attracted attention.

Cellulose is one of the main sources of carbon electrode materials. Carbon electrode materials converted from the cellulose derived from biomass have attracted attention as a precursor of electrode materials. They have significant advantages including wide range of sources, large output, environmentally friendly preparation, being renewable, excellent mechanical performance, multiple modification sites, reducing the emissions of pollutants in the production process of conventional graphite electrodes, lowering production costs, and making full use of biomass waste resources, which helps to promote a large-scale production of the environmentally friendly and low-cost anode materials for lithium-ion battery, with significant social significance and economic value. Carbon electrode materials have a wide range of applications in fields such as energy storage and conversion. However, the low theoretical capacity, low energy density and poor cycle stability of conventional carbon electrode materials limit their application in lithium batteries.

### SUMMARY

The present disclosure aims to solve at least one of the above-mentioned technical problems existing in the prior art. For this purpose, the present disclosure provides a method for preparing a porous microsphere carbon anode material and an application thereof.

According to a first aspect of the present disclosure, a method for preparing a porous microsphere carbon anode material is provided, comprising steps of:
S1: mixing plant fiber with a halogenated lithium salt to obtain a mixed solid, heating the mixed solid and introducing an oxidizing gas to obtain a pre-dissociated product;
S2: mixing the pre-dissociated product with a dissociation solution, heating for reaction in a closed environment, and performing a solid-liquid separation after the reaction to obtain a dissociated cellulose solution, wherein the dissociation solution is a mixed solution of halogenated choline and lithium hypochlorite; and
S3: adding a hybrid to the dissociated cellulose solution to obtain a hybrid solution, spray-drying the hybrid solution to obtain a microsphere precursor, and heating the microsphere precursor in an inert atmosphere to obtain the porous microsphere carbon anode material, wherein the hybrid is selected from the group consisting of silicic acid, lithium silicate and a mixture thereof.

In some embodiments of the present disclosure, in step S1, the plant fiber has a particle size distribution of D50≤0.5 mm. Optionally, the plant fiber is prepared by drying and crushing a plant pompon. The plant pompon is crushed into powder to increase the exposed area of the plant pompon cellulose.

In some preferred embodiments of present disclosure, the plant pompon is selected from the group consisting of Conyza, Taraxacum, Calliandra, Ageratum and a mixture thereof.

In some preferred embodiments of the present disclosure, in step S1, the drying is carried out at a temperature of 80-100° C. to a constant weight.

In some embodiments of the present disclosure, in step S1, a mass ratio of the plant fiber to the halogenated lithium salt is 100:(1-10).

In some embodiments of the present disclosure, in step S1, the halogenated lithium salt is selected from the group consisting of lithium chloride, lithium bromide and a mixture thereof.

In some embodiments of the present disclosure, in step S1, the heating is carried out at a temperature of 75-120° C. The interaction of Li⁺ and Cl⁻ with the hydroxyl groups of cellulose will initially break the hydrogen bonds between some cellulose chains at high temperature, which has the effect of pre-dissociation.

In some embodiments of the present disclosure, in step S1, the oxidizing gas is chlorine gas or bromine gas, and a gas-solid ratio of the oxidizing gas to the mixed solid is 100:(1-30) mL/g. Further, the oxidizing gas is chlorine gas. Scouring with the oxidizing gas has the effects of pre-oxidation and pre-dissociation, facilitating the following oxidation and dissociation of the plant fiber by the dissociation solution.

In some embodiments of the present disclosure, in step S2, the mixed solution has the halogenated choline with a concentration of 0.1-1 g/L and the lithium hypochlorite with a concentration of 0.5-5 g/L. Halogenated choline serves to promote the effect of dissociation solution. Halogenated choline promotes the swelling of cellulose to form a homogeneous mixture, and is used for accelerating the oxidation and dissociation of cellulose.

In some embodiments of the present disclosure, in step S2, the heating is carried out at a temperature of 75-120° C. Heating in a closed environment prevents gas from escaping and thus facilitates oxidation of cellulose. Further, the heating is carried out for 5-30 min.

In some embodiments of the present disclosure, in step S2, a solid residue and an overflowing gas are also obtained by the solid-liquid separation. The solid residue is returned to step S1 to be mixed with the halogenated lithium salt for re-dissociation, and the overflowing gas can be returned to the heating process in step S1 to be used as an oxidizing gas.

In some embodiments of the present disclosure, in step S2, the halogenated choline is selected from the group consisting of choline chloride or its derivative, choline bromide or its derivative, choline iodide or its derivative, and a mixture thereof.

In some embodiments of the present disclosure, in step S3, the dissociated cellulose solution has a carbon concentration of 0.5 wt %-3 wt %, and a solid-liquid ratio of the hybrid to the dissociated cellulose solution is (0.01-1):100 g/mL. Preferably, the carbon concentration of the dissociated cellulose solution is adjusted to 0.8-2 wt %. The carbon concentration of the dissociated cellulose solution is adjusted by diluting with water or concentrating. The carbon concentration is adjusted to facilitate the following hybridization treatment by adding a hybrid. Controlling the silicon-carbon ratio in a certain range is beneficial to improve the electrochemical performance of the anode material.

In some embodiments of the present disclosure, in step S3, the inert atmosphere is selected from the group consisting of argon, nitrogen, neon and a mixture thereof. A stream of an inert atmosphere can remove excess functional groups (hydroxyl, aldehyde group, etc.) and carbon species.

In some embodiments of the present disclosure, in step S3, the heating is carried out at a temperature of 400-850° C. for 0.5-6 h.

The second aspect of the present disclosure also provides use of the porous microsphere carbon anode material prepared by the method in preparation of an anode of lithium battery.

The third aspect of the present disclosure also provides use of the porous microsphere carbon anode material prepared by the method in a lithium-ion battery.

According to a preferred embodiment of the present disclosure, there are at least the following beneficial effects.

1. In the present disclosure, the plant fiber is subjected to salt bath treatment with a halogenated lithium salt and scouring with an oxidizing gas. A high-temperature solid phase environment facilitates lithium ions and halogen ions of the halogenated lithium salt to respectively react with oxygen and hydrogen on hydroxyl groups of the cellulose to generate peroxy radicals. The introduction of the oxidizing gas for a higher oxidation reaction promotes the further breaking of the hydrogen bonds and destroys part of the rigid structure of the cellulose. The use of the halogenated lithium salt will not introduce other impurities, and can also achieve the pre-lithiation of the anode material. In addition, the lithium salt and the cellulose will enter the dissociation solution in liquid phase. Without the subsequent addition of salt, the lithium ions and halogen ions of the remaining unreacted lithium salt in the liquid-phase environment will react again with oxygen and hydrogen on hydroxyl groups of the cellulose to facilitate the dissociation by the dissociation solution, thereby significantly increasing the hydrolysis rate of the cellulose.

2. The pre-dissociation treatment based on salt bath heating and gas scouring promotes the formation of defects in the hydroxyl groups of cellulose. Then, the deep eutectic solvent of halogenated choline and the mild oxidation of lithium hypochlorite in the dissociation solution allow the anions provided by the dissociation solution to have electron-induced interaction with the hydrogen atoms on the electron-deficient hydroxyl groups of cellulose and hemicellulose, which can effectively destroy the intermolecular hydrogen bonds in the cellulose and hemicellulose and promote more dissociation and higher dissociation rate.

3. To the dissociated cellulose solution, silicic acid/lithium silicate is added for hybridization treatment. The lithium storage capacity of silicon is higher than that of carbon, and adding lithium can achieve pre-lithiation. By spray-drying under pressure, a microsphere precursor is prepared, which is then heated and introduced with gas stream to obtain a porous microsphere hard carbon anode material. The porous microsphere has abundant defects and pores, which can increase the specific surface area, increase the active sites, promote the contact between the electrode and the electrolyte, and thus improve the reversible lithium storage capacity of the hard carbon.

### BRIEF DESCRIPTION OF DRAWINGS

The present disclosure is further described below in conjunction with the drawings and examples, in which:

FIG. 1 shows an SEM image of the porous microsphere carbon anode material prepared in Example 3 of the present disclosure.

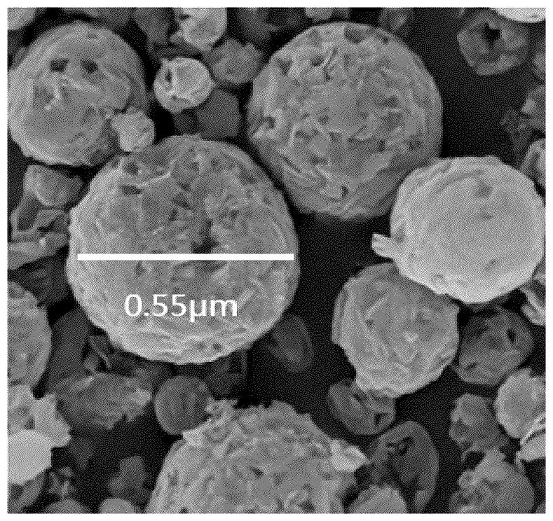

### DETAILED DESCRIPTION

Hereinafter, the concept of the present disclosure and the technical effects produced by the present disclosure will be described clearly and completely in conjunction with the examples, so as to fully understand the purpose, features and effects of the present disclosure. It is apparent that the described examples are only a part of the examples of the present disclosure, rather than all of them. All the other examples obtained by those skilled in the art based on the examples of the present disclosure without any creative work fall into the scope of protection of the present disclosure.

### Example 1

In this example, a porous microsphere carbon anode material was prepared by the following specific processes:

(1) A clean plant pompon (Taraxacum) was dried at 85° C., and then the dried pompon was sent to a crusher for crushing to obtain a pompon powder (D50≤0.5 mm). The pompon powder and lithium chloride were mixed well at a mass ratio of 100:2.5 to obtain a mixed solid. The mixed solid was sent to a heating container for salt bath heating treatment (117° C., for 8 min) and scoured with chlorine gas (at a gas-solid ratio of 100:2.5 mL/g) to obtain a first solid (a pre-dissociated product), and the chlorine gas was recovered.

(2) The first solid and a dissociation solution (0.15 g/L choline chloride+0.87 g/L lithium hypochlorite) were added into an acid-resistant and heat-resistant container, stirred well, maintained at 75° C. for 27 min under continuous stirring, and oxidized in a closed environment to obtain an oxidized first solution containing a solid, which was then separated to obtain a second solid and a second solution (a dissociated cellulose solution).

(3) The second solution was measured for carbon concentration with a carbon sulfur analyzer, diluted to a carbon concentration of 0.53 wt %, added with silicic acid (at a solid-liquid ratio of 0.12:100 g/mL), and mixed well for hybridization treatment to obtain a hybrid solution. The hybrid solution was then introduced into a pressure spray dryer for spray-drying at 150° C. to obtain a microsphere precursor. The microsphere precursor was sent to a tubular furnace, to which a nitrogen gas stream was introduced, sintered at 850° C. for 1.25 h, cooled and washed for 3 times to wash out remaining Si or Li ions on the surface, dried and dehydrated to obtain a porous microsphere carbon anode material.

### Example 2

In this example, a porous microsphere carbon anode material was prepared by the following specific processes:

(1) A clean plant pompon (Taraxacum) was dried at 85° C., and then the dried pompon was sent to a crusher for crushing to obtain a pompon powder (D50≤0.5 mm). The pompon powder and lithium chloride were mixed well at a mass ratio of 100:3.5 to obtain a mixed solid. The mixed solid was sent to a heating container for salt bath heating treatment (110° C., for 12 min) and scoured with chlorine gas (at a gas-solid ratio of 100:8.5 mL/g) to obtain a first solid (a pre-dissociated product), and the chlorine gas was recovered.

(2) The first solid and a dissociation solution (0.2 g/L choline chloride+2 g/L lithium hypochlorite) were added into an acid-resistant and heat-resistant container, stirred well, maintained at 85° C. for 18 min under continuous stirring, and oxidized in a closed environment to obtain an oxidized first solution containing a solid, which was then separated to obtain a second solid and a second solution (a dissociated cellulose solution).

(3) The second solution was measured for carbon concentration with a carbon sulfur analyzer, concentrated to a carbon concentration of 1.2 wt %, added with silicic acid (at a solid-liquid ratio of 0.35:100 g/mL), and mixed well for hybridization treatment to obtain a hybrid solution. The hybrid solution was then introduced into a pressure spray dryer for spray-drying at 150° C. to obtain a microsphere precursor. The microsphere precursor was sent to a tubular furnace, to which a nitrogen gas stream was introduced, sintered at 750° C. for 2.5 h, cooled and washed for several times, dried and dehydrated to obtain a porous microsphere carbon anode material.

### Example 3

In this example, a porous microsphere carbon anode material was prepared by the following specific processes:

(1) A clean plant pompon (Taraxacum) was dried at 95° C., and then the dried pompon was sent to a crusher for crushing to obtain a pompon powder (D50≤0.5 mm). The pompon powder and lithium chloride were mixed well at a mass ratio of 100:5 to obtain a mixed solid. The mixed solid was sent to a heating container for salt bath heating treatment (100° C., for 32 min) and scoured with chlorine gas (at a gas-solid ratio of 100:15 mL/g) to obtain a first solid (a pre-dissociated product), and the chlorine gas was recovered.

(2) The first solid and a dissociation solution (0.6 g/L choline chloride+3.5 g/L lithium hypochlorite) were added into an acid-resistant and heat-resistant container, stirred well, maintained at 95° C. for 10 min under continuous stirring, and oxidized in a closed environment to obtain an oxidized first solution containing a solid, which was then separated to obtain a second solid and a second solution (a dissociated cellulose solution).

(3) The second solution was measured for carbon concentration with a carbon sulfur analyzer, concentrated to a carbon concentration of 1.5 wt %, added with lithium silicate (at a solid-liquid ratio of 0.65:100 g/mL), and mixed well for hybridization treatment to obtain a hybrid solution. The hybrid solution was then introduced into a pressure spray dryer for spray-drying at 150° C. to obtain a microsphere precursor. The microsphere precursor was sent to a tubular furnace, to which a nitrogen gas stream was introduced, sintered at 650° C. for 4.5 h, cooled and washed for 3 times to wash out remaining Si or Li ions on the surface, dried and dehydrated to obtain a porous microsphere carbon anode material.

### Example 4

In this example, a porous microsphere carbon anode material was prepared by the following specific processes:

(1) A clean plant pompon (Calliandra) was dried at 100° C., and then the dried pompon was sent to a crusher for crushing to obtain a pompon powder (D50≤0.5 mm). The pompon powder and lithium chloride were mixed well at a mass ratio of 100:10 to obtain a mixed solid. The mixed solid was sent to a heating container for salt bath heating treatment (80° C., for 45 min) and scoured with chlorine gas (at a gas-solid ratio of 100:30 mL/g) to obtain a first solid (a pre-dissociated product), and the chlorine gas was recovered.

(2) The first solid and a dissociation solution (0.8 g/L choline chloride+5 g/L lithium hypochlorite) were added into an acid-resistant and heat-resistant container, stirred well, maintained at 120° C. for 2 min under continuous stirring, and oxidized in a closed environment to obtain an oxidized first solution containing a solid, which was then separated to obtain a second solid and a second solution (a dissociated cellulose solution).

(3) The second solution was measured for carbon concentration with a carbon sulfur analyzer, concentrated to a carbon concentration of 2 wt %, added with lithium silicate (at a solid-liquid ratio of 0.65:100 g/mL), and mixed well for hybridization treatment to obtain a hybrid solution. The hybrid solution was then introduced into a pressure spray dryer for spray-drying at 150° C. to obtain a microsphere precursor. The microsphere precursor was sent to a tubular furnace, to which a nitrogen gas stream was introduced, sintered at 550° C. for 6 h, cooled and washed for 3 times to wash out remaining Si or Li ions on the surface, dried and dehydrated to obtain a porous microsphere carbon anode material.

### Comparative Example 1

In this comparative example, a porous microsphere carbon anode material was prepared by the following specific processes, which differed from Example 4 in that there was no lithium chloride added, no salt bath heating and no scouring with chlorine gas in step (1).

(1) A clean plant pompon (Calliandra) was dried at 100° C., and then the dried pompon was sent to a crusher for crushing to obtain a pompon powder (D50≤0.5 mm, a first solid).

(2) The crushed pompon powder and a dissociation solution (0.8 g/L choline chloride+5 g/L lithium hypochlorite) were added into an acid-resistant and heat-resistant container, stirred well, maintained at 120° C. for 2 min under continuous stirring, and oxidized in a closed environment to obtain an oxidized first solution containing a solid, which was then separated to obtain a second solid and a second solution.

(3) The second solution was measured for carbon concentration with a carbon sulfur analyzer, concentrated to a carbon concentration of 2 wt %, added with lithium silicate (at a solid-liquid ratio of 0.65:100 g/mL), and mixed well for hybridization treatment to obtain a hybrid solution. The hybrid solution was then introduced into a pressure spray dryer for spray-drying at 150° C. to obtain a microsphere precursor. The microsphere precursor was sent to a tubular furnace, to which a nitrogen gas stream was introduced, sintered at 550° C. for 6 h, cooled and washed for 3 times, dried and dehydrated to obtain a porous microsphere carbon anode material.

### Comparative Example 2

In this comparative example, a porous microsphere carbon anode material was prepared by the following specific processes, which differed from Example 3 in that step (2) was not performed.

(1) A clean plant pompon (Taraxacum) was dried at 95° C., and then the dried pompon was sent to a crusher for crushing to obtain a pompon powder (D50≤0.5 mm). The pompon powder and lithium chloride were mixed well at a mass ratio of 100:5 to obtain a mixed solid. The mixed solid was sent to a heating container for salt bath heating treatment (100° C., for 32 min) and scoured with chlorine gas (at a gas-solid ratio of 100:15 mL/g) to obtain a first solid, and the chlorine gas was recovered.

(2) The first solid was dispersed in water to a carbon concentration of 1.5 wt %, added with lithium silicate (at a solid-liquid ratio of 0.65:100 g/mL), and mixed well for hybridization treatment to obtain a hybrid solution. The hybrid solution was then introduced into a pressure spray dryer for spray-drying at 150° C. to obtain a microsphere precursor. The microsphere precursor was sent to a tubular furnace, to which a nitrogen gas stream was introduced, sintered at 650° C. for 4.5 h, cooled and washed for 3 times, dried and dehydrated to obtain a porous microsphere carbon anode material.

### Comparative Example 3

In this comparative example, a porous microsphere carbon anode material was prepared by the following specific processes, which differed from Example 2 in that silicic acid was not added in step (3).

(1) A clean plant pompon (Taraxacum) was dried at 85° C., and then the dried pompon was sent to a crusher for crushing to obtain a pompon powder (D50≤0.5 mm). The pompon powder and lithium chloride were mixed well at a mass ratio of 100:3.5 to obtain a mixed solid. The mixed solid was sent to a heating container for salt bath heating treatment (110° C., for 12 min) and scoured with chlorine gas (at a gas-solid ratio of 100:8.5 mL/g) to obtain a first solid, and the chlorine gas was recovered.

(2) The first solid and a dissociation solution (0.2 g/L choline chloride+2 g/L lithium hypochlorite) were added into an acid-resistant and heat-resistant container, stirred well, maintained at 85° C. for 18 min under continuous stirring, and oxidized in a closed environment to obtain an oxidized first solution containing a solid, which was then separated to obtain a second solid and a second solution.

(3) The second solution was measured for carbon concentration with a carbon sulfur analyzer, concentrated to a carbon concentration of 1.2 wt %, and then introduced into a pressure spray dryer for spray-drying at 150° C. to obtain a microsphere precursor. The microsphere precursor was sent to a tubular furnace, to which a nitrogen gas stream was introduced, sintered at 750° C. for 2.5 h, cooled and washed for 3 times, dried and dehydrated to obtain a porous microsphere carbon anode material.

TABLE 1
Specific surface area and D50 data of materials
in Examples 1-4 and Comparative Examples 1-3

| Sample | Specific surface area (m²/g) | D50 (μm) |
|---|---|---|
| Example 1 | 0.83 | 0.43 |
| Example 2 | 0.82 | 0.51 |
| Example 3 | 0.87 | 0.48 |
| Example 4 | 0.89 | 0.49 |
| Comparative Example 1 | 0.73 | 0.43 |
| Comparative Example 2 | 0.75 | 0.45 |
| Comparative Example 3 | 0.86 | 0.45 |

As can be seen from Table 1, Comparative Examples 1 and 2 had a specific surface area that was significantly lower than that of the Examples. It is because that the insufficient dissociation in the Comparative Examples lead to incomplete breaking of hydrogen bonds in the cellulose, which further affected the efficiency of pore-making by air flow, resulting in a lower BET.

TABLE 2
Dissociation rate of the first solid in Examples
1-4 and Comparative Examples 1 and 3

| Sample | Dissociation rate of the first solid (%) |
|---|---|
| Examples 1 | 65.7 |
| Examples 2 | 66.3 |
| Examples 3 | 71.2 |
| Examples 4 | 68.4 |
| Comparative Examples 1 | 54.7 |
| Comparative Examples 3 | 67.3 |

Note:
Dissociation rate of the first solid (%) = (mass of the first solid − mass of the second solid)/mass of the first solid * 100%.

As can be seen from Table 2, since Comparative Example 1 was not subjected to the pre-dissociation treatment, it had a significantly lower dissociation rate than the Examples and Comparative Example 3.

### Test Example

The anode materials prepared in Examples 1-4 and Comparative Examples 1-3, acetylene black and polyvinylidene fluoride were dissolved in N-methylpyrrolidone at a mass ratio of 8:1:1 and ground to form a paste-like active material. A Cu foil substrate was then uniformly coated with the paste-like active material, placed in a vacuum oven, and dried at 85° C. for 8 h to prepare an electrode sheet. The lithium sheet was used as a counter electrode and a solution of 1 mol/L of lithium hexafluorophosphate (LiPF₆) in EC/DMC/DEC (a mixed solvent with a mass ratio of 1:1:1) as the electrolyte to assemble the CR2025 type button cell in a glove box, which was tested for electrochemical performance at a current density of 0.1 A/g and 0.01-3 V on a LAND type battery test system. The results were shown in Table 3.

TABLE 3
Electrochemical performance test data of Examples 1-4 and Comparative Examples 1-3

| | Initial | 30^{th} | 100^{th} | | | |
|---|---|---|---|---|---|---|
| | discharge | discharge | discharge | Initial | 30^{th} | 100^{th} |
| | specific | specific | specific | Coulombic | Coulombic | Coulombic |
| | capacity | capacity | capacity | efficiency | efficiency | efficiency |
| Sample | (mAh/g) | (mAh/g) | (mAh/g) | (%) | (%) | (%) |
| Example 1 | 381.2 | 362.3 | 353.5 | 80.75 | 90.51 | 94.63 |
| Example 2 | 386.7 | 361.4 | 352.6 | 81.19 | 89.07 | 93.92 |
| Example 3 | 391.1 | 369.8 | 360.8 | 82.29 | 90.11 | 94.22 |
| Example 4 | 396.4 | 387.1 | 377.7 | 81.89 | 92.84 | 98.17 |
| Comparative | 379.2 | 340.7 | 323.8 | 72.12 | 84.83 | 88.70 |
| Example 1 | | | | | | |
| Comparative | 345.3 | 322.7 | 310.1 | 71.89 | 83.60 | 91.10 |
| Example 2 | | | | | | |
| Comparative | 368.4 | 302.0 | 294.7 | 75.36 | 78.64 | 82.77 |
| Example 3 | | | | | | |

It can be seen from Table 3 that performances of the sample in the Examples were all higher than those in the Comparative Examples with regard to the initial, 30^{th} and 100^{th} discharge specific capacity, and the samples in the Examples also had a certain advantage with regard to the Coulombic efficiency. It is because that Comparative Example 1 and Comparative Example 2 did not undergo sufficient dissociation, resulting in a lower porosity than that of the Examples. Therefore, the specific surface area was relatively low, which affected the reversible lithium storage capacity of hard carbon. Comparative Example 3 did not undergo hybridization treatment, resulting in lower silicon content than that of the Examples. Therefore, the lithium storage capacity was reduced, leading to a lower specific capacity.

The examples of the present disclosure have been described in detail above in conjunction with the drawings. However, the present disclosure is not limited to the above-mentioned examples, and various modifications can be made without departing from the purpose of the present disclosure within the scope of knowledge possessed by those of ordinary skill in the art. In addition, in the case of no conflict, the examples and the features in the examples of the present disclosure may be combined with each other.

1. A method for preparing a porous microsphere carbon anode material, comprising steps of:
S1: mixing plant fiber with a halogenated lithium salt to obtain a mixed solid, heating the mixed solid and introducing an oxidizing gas to obtain a pre-dissociated product;
S2: mixing the pre-dissociated product with a dissociation solution, heating for reaction in a closed environment, and performing a solid-liquid separation after the reaction to obtain a dissociated cellulose solution, wherein the dissociation solution is a mixed solution of halogenated choline and lithium hypochlorite; and
S3: adding a hybrid to the dissociated cellulose solution to obtain a hybrid solution, spray-drying the hybrid solution to obtain a microsphere precursor, and heating the microsphere precursor in an inert atmosphere to obtain the porous microsphere carbon anode material, wherein the hybrid is selected from the group consisting of silicic acid, lithium silicate and a mixture thereof.

2. The method according to claim 1, wherein in step S1, the plant fiber has a particle size distribution of D50≤0.5 mm.

3. The method according to claim 1, wherein in step S1, a mass ratio of the plant fiber to the halogenated lithium salt is 100:(1-10).

4. The method according to claim 1, wherein in step S1, the halogenated lithium salt is selected from the group consisting of lithium chloride, lithium bromide and a mixture thereof.

5. The method according to claim 1, wherein in step S1, the heating is carried out at a temperature of 75-120° C.

6. The method according to claim 1, wherein in step S1, the oxidizing gas is chlorine gas, and a gas-solid ratio of the oxidizing gas to the mixed solid is 100:(1-30) mL/g.

7. The method according to claim 1, wherein in step S2, the mixed solution has the halogenated choline with a concentration of 0.1-1 g/L and the lithium hypochlorite with a concentration of 0.5-5 g/L.

8. The method according to claim 1, wherein in step S2, the heating is carried out at a temperature of 75-120° C.

9. The method according to claim 1, wherein in step S3, the dissociated cellulose solution has a carbon concentration of 0.5 wt %-3 wt %, and a solid-liquid ratio of the hybrid to the dissociated cellulose solution is (0.01-1):100 g/mL.

10. Use of the porous microsphere carbon anode material prepared by the method according to claim 1 in preparation of an anode of lithium battery or a lithium-ion battery.

11. Use of the porous microsphere carbon anode material prepared by the method according to claim 2 in preparation of an anode of lithium battery or a lithium-ion battery.

12. Use of the porous microsphere carbon anode material prepared by the method according to claim 3 in preparation of an anode of lithium battery or a lithium-ion battery.

13. Use of the porous microsphere carbon anode material prepared by the method according to claim 4 in preparation of an anode of lithium battery or a lithium-ion battery.

14. Use of the porous microsphere carbon anode material prepared by the method according to claim 5 in preparation of an anode of lithium battery or a lithium-ion battery.

15. Use of the porous microsphere carbon anode material prepared by the method according to claim 6 in preparation of an anode of lithium battery or a lithium-ion battery.

16. Use of the porous microsphere carbon anode material prepared by the method according to claim 7 in preparation of an anode of lithium battery or a lithium-ion battery.

17. Use of the porous microsphere carbon anode material prepared by the method according to claim 8 in preparation of an anode of lithium battery or a lithium-ion battery.

18. Use of the porous microsphere carbon anode material prepared by the method according to claim 9 in preparation of an anode of lithium battery or a lithium-ion battery.
